(19) United States
(12) Patent Application Publication
(10) Pub. No.: US 2014/0213107 A1
(43) Pub. Date: Jul. 31, 2014

(54) COAXIAL CONNECTOR

(71) Applicant: MURATA MANUFACTURING CO., LTD., Kyoto (JP)

(72) Inventors: Yoshihiro HIMI, Kyoto (JP); Susumu HASHIMOTO, Kyoto (JP); Yuichi MARUYAMA, Kyoto (JP); Takeshi ARAI, Kyoto (JP)

(73) Assignee: MURATA MANUFACTURING CO., LTD., Kyoto (JP)

(21) Appl. No.: 14/248,746

(22) Filed: Apr. 9, 2014

Related U.S. Application Data
(63) Continuation of application No. PCT/JP2012/071420, filed on Aug. 24, 2012.

(30) Foreign Application Priority Data
Oct. 19, 2011 (JP) 2011-229848

(51) Int. Cl. H01R 9/05

(52) U.S. Cl. CPC H01R 9/0518
USPC 439/585

(57) ABSTRACT

A coaxial connector that can be prevented from being detached from a coaxial cable. A coaxial connector is attached to a coaxial cable including a central conductor, an insulating body having a foam structure or a hollow structure, an outer conductor, and an insulating film. A housing includes a cylindrical part, and a holding part extending from the cylindrical part in the x-axis direction. A bushing is attached to the housing. A socket is located at the center of the cylindrical part in plan view in the z-axis direction, and is connected to the central conductor. The holding part includes a crimp portion that holds the outer conductor, and a crimp portion that holds the insulating film. The crimp portion has a protrusion at a surface which contacts the insulating film.

### CROSS REFERENCE TO RELATED APPLICATIONS

This application claims benefit of priority to Japanese Patent Application No. 2011-229848 filed on Oct. 19, 2011, and to International Patent Application No. PCT/JP2012/071420 filed on Aug. 24, 2012, the entire content of each of which is incorporated herein by reference.

### TECHNICAL FIELD

The present technical field relates to coaxial connectors, and more particularly relates to a coaxial connector that is attached to a distal end of a coaxial cable.

### BACKGROUND

A known coaxial connector of related art is, for example, an L-type coaxial connector described in Japanese Unexamined Patent Application Publication No. 2010-67425. FIG. 13 is an exploded perspective view of the L-type coaxial connector 110 described in Japanese Unexamined Patent Application Publication No. 2010-67425.

As shown in FIG. 13, a housing 112 is connected to an outer conductor 222. A bushing 114 is attached to the housing 112. A socket 116 is attached to the bushing 114, and is insulated from the housing 112 by the bushing 114. The housing 112 includes a crimp portion 126 that is bent and hence crimped to the bushing 114, and a crimp portion 130 that is bent and hence crimped to an insulating film 221 of a coaxial cable 220. The bushing 114 is crimped to an insulating body 223 by a force from the crimp portion 126. The socket 116 breaks the insulating body 223 by a force from the bushing 114 and is connected to a central conductor 224.

Meanwhile, in recent years, use of the insulating body 223 having a foam structure or a hollow structure in the coaxial cable 220 is suggested. Accordingly, the dielectric constant of the insulating body 223 becomes low, and accordingly the outer conductor 222 and the central conductor 224 can be closely arranged. Consequently, by increasing the diameter of the central conductor 224, the conductor loss of the coaxial cable 220 can be decreased without changing the characteristic impedance of the coaxial cable 220 from a desired value.

However, since the coaxial cable 220 uses the insulating body 223 having the foam structure or the hollow structure, the elasticity of the coaxial cable 220 may become low. Hence, when the coaxial cable 220 is held by the crimp portions 126 and 130, since the repulsive force of the coaxial cable 220 is low, the coaxial cable 220 may be detached from the L-type coaxial connector 110.

To prevent the detachment, the crimp portions 126 and 130 may be crimped to the coaxial cable 220 by stronger forces. However, since the insulating body 223 having the foam structure or the hollow structure is easily deformed, the coaxial cable 220 may be deformed at portions where the crimp portions 126 and 130 are crimped to the coaxial cable 220, and the characteristic impedance of the coaxial cable 220 may be changed from the desired value.

### SUMMARY

### Technical Problem

Accordingly, an object of the present disclosure is to provide a coaxial connector that can be prevented from being detached from a coaxial cable including an insulating body having a foam structure or a hollow structure.

### Solution to Problem

According to an aspect of the disclosure, a coaxial connector that is attached to a coaxial cable is provided. The coaxial cable includes a first central conductor, an insulating body provided around the first central conductor and having a foam structure or a hollow structure. A first outer conductor is provided around the insulating body. An insulating film is provided around the first outer conductor. The insulating film is removed at a distal end of the coaxial cable and the first outer conductor is exposed. The first outer conductor is removed at the distal end of the coaxial cable and the insulating body is exposed. The coaxial connector includes a housing including a cylindrical part having a central axis being substantially orthogonal to an extending direction of the coaxial cable, and a holding part extending from the cylindrical part along the coaxial cable. A bushing is attached to the housing. A socket is located at the center of the cylindrical part in plan view in a direction in which the central axis extends, insulated from the housing by the bushing, and connected to the first central conductor. The holding part includes a first crimp portion that holds the first outer conductor, and a second crimp portion that holds the insulating film. The second crimp portion has a protrusion at a surface which contacts the insulating film.

### Advantageous Effects of Disclosure

With the disclosure, the coaxial connector can be prevented from being detached from the coaxial cable including the insulating body having the foam structure or the hollow structure.

### BRIEF DESCRIPTION OF THE DRAWINGS

FIG. 1 is an external perspective view of a coaxial connector according to an embodiment of the disclosure.

FIG. 2 is an exploded perspective view of the coaxial connector.

FIGS. 3(a) and 3(b) provide sectional structure diagrams of the coaxial connector.

FIG. 4 is a perspective view in the middle of assembly of a housing of the coaxial connector.

FIG. 5 is an exploded perspective view in the middle of the assembly of the coaxial connector.

FIG. 6 is an exploded perspective view in the middle of the assembly of the coaxial connector.

FIG. 7 is an exploded perspective view of a coaxial connector according to a first modification.

FIG. 8 is an external perspective view of a coaxial connector according to a second modification.

FIG. 9 is a plan view in the y-axis direction of the coaxial connector in FIG. 1.

FIG. 10 is a plan view in the y-axis direction of the coaxial connector in FIG. 8.

FIG. 11 is a plan view in the x-axis direction of a coaxial connector when a crimp portion is not wound around a coaxial cable.

FIG. 12 is a plan view in the x-axis direction of a coaxial connector when a crimp portion is not wound around a coaxial cable.

FIG. 13 is an exploded perspective view of an L-type coaxial connector described in Japanese Unexamined Patent Application Publication No. 2010-67425.

### DETAILED DESCRIPTION

Hereinafter, a coaxial connector according to an embodiment of the disclosure is described with reference to the drawings.

### (Configuration of Coaxial Connector)

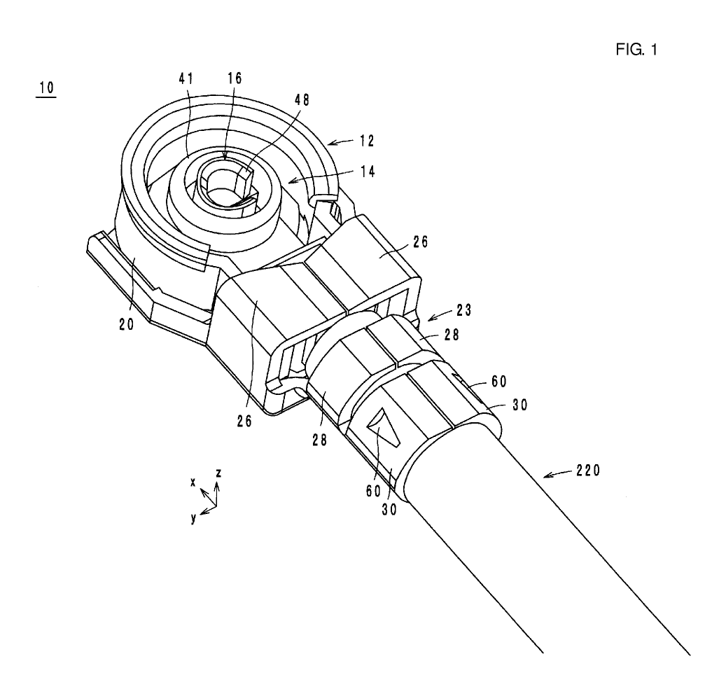

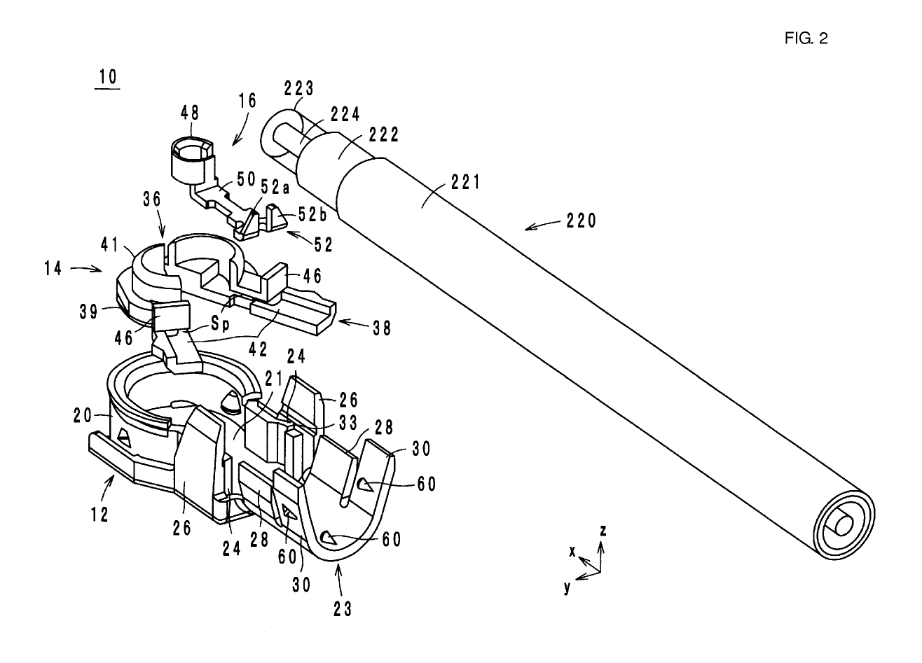

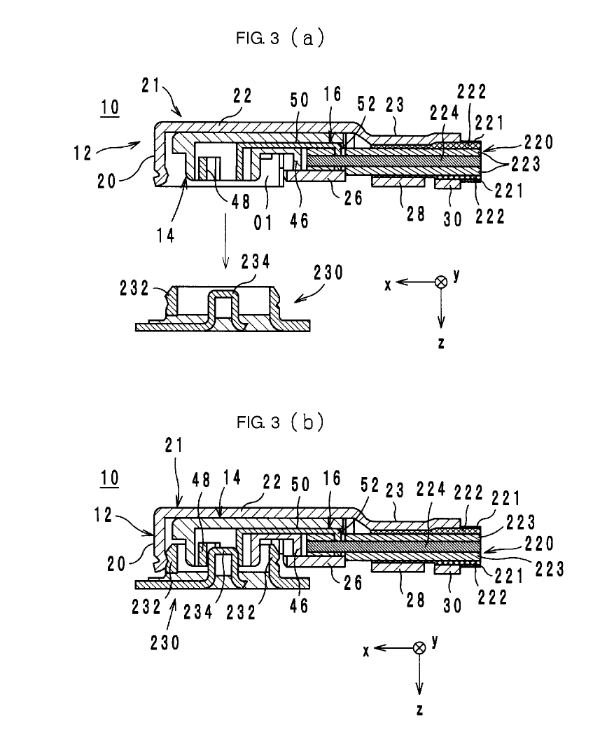

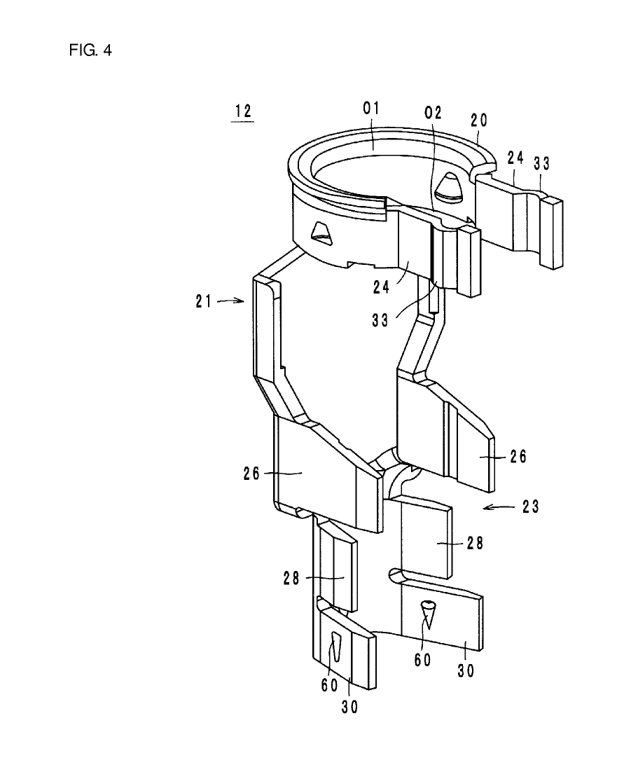

FIG. 1 is an external perspective view of a coaxial connector 10 according to an embodiment of the disclosure. FIG. 2 is an exploded perspective view of the coaxial connector 10. FIG. 3 provides sectional structure diagrams of the coaxial connector 10. FIG. 4 is a perspective view in the middle of assembly of a housing 12 of the coaxial connector 10. In FIGS. 1 to 3 (in particular, see FIG. 2), it is assumed that the z-axis direction represents a direction in which the housing 12, a bushing 14, and a socket 16 are stacked. The positive direction in the z-axis direction is a direction from the housing 12 toward the socket 16. Also, it is assumed that the x-axis direction represents a direction in which a coaxial cable 220 extends, and the y-axis direction represents a direction being orthogonal to the x-axis direction and the z-axis direction. The positive direction in the x-axis direction is a direction from the coaxial cable 220 toward the socket 16. The x-axis direction is orthogonal to the z-axis direction.

As shown in FIGS. 1 and 2, the coaxial connector 10 includes the housing 12, the bushing 14, and the socket 16. As shown in FIGS. 3(a) and 3(b), the coaxial connector 10 is detachably attached to a receptacle 230 having an outer conductor 232 and a central conductor 234.

As shown in FIG. 2, the coaxial cable 220 includes an insulating film 221, an outer conductor 222, an insulating body 223, and a central conductor 224. The insulating body 223 is provided around the central conductor 224, and has a foam structure or a hollow structure. Accordingly, the insulating body 223 has only a low repulsive force, and is relatively easily deformed. The outer conductor 222 is provided around the insulating body 223. The insulating film 221 is provided around the outer conductor 222. Also, the insulating film 221 is removed at a distal end of the coaxial cable 220 and the outer conductor 222 is exposed. Further, the outer conductor 222 is removed at the distal end of the coaxial cable 220, and the insulating body 223 is exposed.

The housing 12 is formed of a single metal plate (for example, phosphor bronze for springs). As shown in FIGS. 2 and 4, the housing 12 includes a cylindrical part 20, a rear surface part 21, a holding part 23, and a fixing part 24.

The cylindrical part 20 has the central axis extending in the z-axis direction, and has an opening O1 located at the positive-direction side in the z-axis direction and an opening O2 located at the negative-direction side in the z-axis direction as shown in FIG. 4. A portion (at the negative-direction side in the x-axis direction) of the cylindrical part 20 is cut.

The rear surface part 21 is connected to the cylindrical part 20. The rear surface part 21 is a plate-like member that is bent only by 90 degrees from a state in FIG. 4 and covers the opening O2 of the cylindrical part 20 as shown in FIG. 2. The bushing 14 is mounted on the rear surface part 21.

The fixing part 24 is connected to the cylindrical part 20. As shown in FIG. 2, the fixing part 24 pinches the bushing 14 from both sides in the y-axis direction. As shown in FIG. 4, the fixing part 24 is provided at each of end portions of the cylindrical part 20 in plan view of the opening O1 from the positive-direction side in the z-axis direction. To be specific, two fixing parts 24 are plate-like members that extend from two end portions, which are formed by cutting the cylindrical part 20, toward the negative-direction side in the x-axis direction, and that face each other.

Also, the fixing parts 24 are provided with respective curve portions 33. As shown in FIG. 4, the curve portions 33 are formed by curving portions of the fixing parts toward the positive-direction side or the negative-direction side in the y-axis direction so that the distance between the fixing parts 24 is increased.

As shown in FIGS. 1 and 2, the holding part 23 extends from the cylindrical part 20 along the coaxial cable 220. To be specific, the holding part 23 is connected to the negative-direction side in the x-axis direction of the rear surface part 21. As shown in FIG. 4, the holding part 23 includes crimp portions 26, 28, and 30.

As shown in FIG. 2, the crimp portion 26 is a U-shaped plate-like member provided at the negative-direction side in the x-axis direction of the rear surface part 21 before assembly of the coaxial connector 10. By bending the crimp portion 26 as shown in FIG. 1, the crimp portion 26 is wound around the bushing 14, the fixing part 24, and the insulating body 223. Accordingly, the crimp portion 26 is crimped to the bushing 14, the fixing part 24, and the insulating body 223. At this time, the fixing part 24 is pressed by the crimp portion 26 and thus is crimped to the bushing 14. Hence, the fixing part 24 and the crimp portion 26 hold the bushing 14. With the above-described configuration, the crimp portion 26 has a role of fixing the bushing 14, the socket 16, and the coaxial cable 220 to the housing 12.

As shown in FIG. 4, the crimp portion 28 is a U-shaped plate-like member provided at the negative-direction side in the x-axis direction of the crimp portion 26 before assembly of the coaxial connector 10. By bending the crimp portion 28 as shown in FIG. 1, the crimp portion 28 is wound around the outer conductor 222, and holds the outer conductor 222 of the coaxial cable 220. Accordingly, the crimp portion 28 has a role of fixing the coaxial cable 220 to the housing 12, and a role of electrically connecting the outer conductor 222 with the housing 12.

As shown in FIG. 4, the crimp portion 30 is a U-shaped plate-like member provided at the negative-direction side in the x-axis direction of the crimp portion 28 before assembly of the coaxial connector 10. By bending the crimp portion 30 as shown in FIG. 1, the crimp portion 30 is wound around the insulating film 221, and holds the insulating film 221 of the coaxial cable 220. Accordingly, the crimp portion 30 has a role of fixing the coaxial cable 220 to the housing 12.

Further, as shown in FIGS. 1, 2, and 4, the crimp portion 30 has a plurality of (three) protrusions 60 at a surface which contacts the insulating film 221. The protrusions 60 protrude toward the insulating film 221. To be more specific, the protrusions 60 are provided to be located at equal intervals in the circumferential direction of the insulating film 221 when the crimp portion 30 is wound around the insulating film 221. Also, each of the protrusions 60 has an isosceles triangle shape in which the apex is farther from the cylindrical part 20 than the base is (that is, located at the negative-position side in the x-axis direction) in plan view in a protruding direction. In the protrusion 60, the most protruding portion toward the insulating film 221 is the midpoint of the base of the isosceles triangle. Also, the protrusion 60 protrudes in a sharp form toward the insulating film 221. Consequently, when the crimp portion 30 is wound around the insulating film 221, the protrusion 60 sticks to or bites into the insulating film 221.

The bushing 14 is formed of an insulating body made of resin (for example, liquid crystal polymer). The bushing 14 has a role of insulating the housing 12 from the socket 16. The bushing 14 is attached to the housing 12. As shown in FIG. 2, the bushing 14 includes a circular part 36 and a holding part 38.

The circular part 36 has a role of holding the socket 16. As shown in FIG. 2, the circular part 36 includes a rear surface portion 39 and a cylindrical portion 41. The rear surface portion 39 is a circular plate-like member in plan view in the z-axis direction. The rear surface portion 39 is housed in the cylindrical part 20 as shown in FIG. 1 when the bushing 14 is attached to the housing 12.

As shown in FIG. 2, the cylindrical portion 41 is provided on a surface at the positive-direction side in the z-axis direction of the rear surface portion 39. The cylindrical portion 41 has the central axis extending in the z-axis direction. The central axis of the cylindrical portion 41 is substantially aligned with the central axis of the cylindrical part 20.

The holding part 38 has a role of holding the socket 16. As shown in FIG. 2, the holding part 38 includes a rear surface portion 42 and a pressing portion 46. The rear surface portion 42 is a rectangular plate-like member extending from the rear surface portion 39 of the circular part 36 toward the negative-direction side in the x-axis direction. As shown in FIG. 2, the socket 16 is mounted on the rear surface portion 42.

The pressing portion 46 is a plate-like member being perpendicular to the x-axis direction, and is provided at the rear surface portion 42. A gap Sp is provided between an end portion at the negative-direction side in the z-axis direction of the pressing portion 46 and a surface at the positive-direction side in the z-axis direction of the rear surface portion 42. Similarly, a gap Sp is provided between the cylindrical portion 41 and a surface at the positive-direction side in the z-axis direction of the rear surface portion 42. Accordingly, a space at the negative-direction side in the x-axis direction of the pressing portion 46 communicates with the inside of the cylindrical portion 41 through the gaps Sp.

Also, as shown in FIG. 2, the bushing 14 can be divided into two. To be specific, the bushing 14 is divided in a V shape including a half portion at the positive-direction side in the y-axis direction and a half portion at the negative-direction side in the y-axis direction. Accordingly, the socket 16 (described later) can be attached to the bushing 14.

The socket 16 is formed of a single metal plate (for example, phosphor bronze for springs). As shown in FIGS. 1 and 2, the socket 16 is attached to the bushing 14, and is insulated from the housing 12 by the bushing 14. As shown in FIG. 2, the socket 16 includes a cylindrical part 48, a rear surface part 50, and an attachment part 52. As shown in FIG. 2, the cylindrical part 48 is connected at the positive-direction side in the x-axis direction of the rear surface part 50. The cylindrical part 48 has a shape in which a portion of a ring is cut in plan view in the z-axis direction. The radius of the cylindrical part 48 is smaller than the radius of the cylindrical portion 41 of the bushing 14. Accordingly, the cylindrical part 48 is housed in the cylindrical portion 41 as shown in FIG. 1 when the coaxial connector 10 is assembled. Further, the cylindrical portion 41 is located at the center of the cylindrical part 20 in plan view in a direction in which the central axis of the cylindrical part 20 extends (z-axis direction).

The rear surface part 50 is a plate-like member extending from the cylindrical portion 41 toward the negative-direction side in the x-axis direction so as to pass through the gaps Sp. The attachment part 52 is provided at an end portion at the negative-direction side in the x-axis direction of the rear surface part 50. The attachment part 52 is perpendicularly bent toward the positive-direction side in the z-axis direction. The attachment part 52 is connected to the central conductor 224 of the coaxial cable 220. To be more specific, the attachment part 52 includes two cutting pieces 52a and 52b arranged side by side with a predetermined gap interposed therebetween. The coaxial cable 220 is pressed to the cutting pieces 52a and 52b by the crimp portion 26 from the positive-direction side toward the negative-direction side in the z-axis direction so that the central conductor 224 of the coaxial cable 220 is arranged at the predetermined gap between the cutting pieces 52a and 52b. Accordingly, the cutting pieces 52a and 52b are crimped to the insulating body 223 of the coaxial cable 220 by a force from the crimp portion 26. Then, the cutting pieces 52a and 52b cut (break) a portion of the insulating body 223 of the coaxial cable 220, and are connected to the central conductor 224.

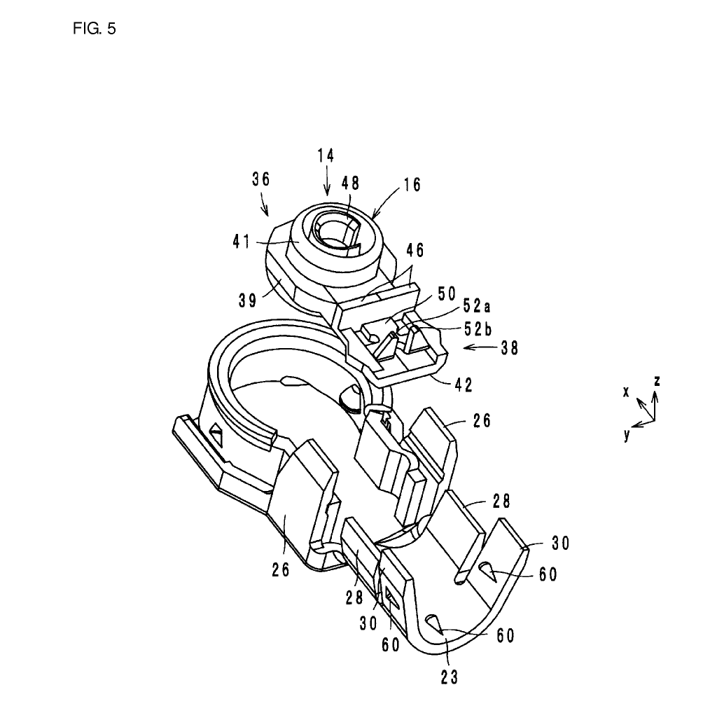

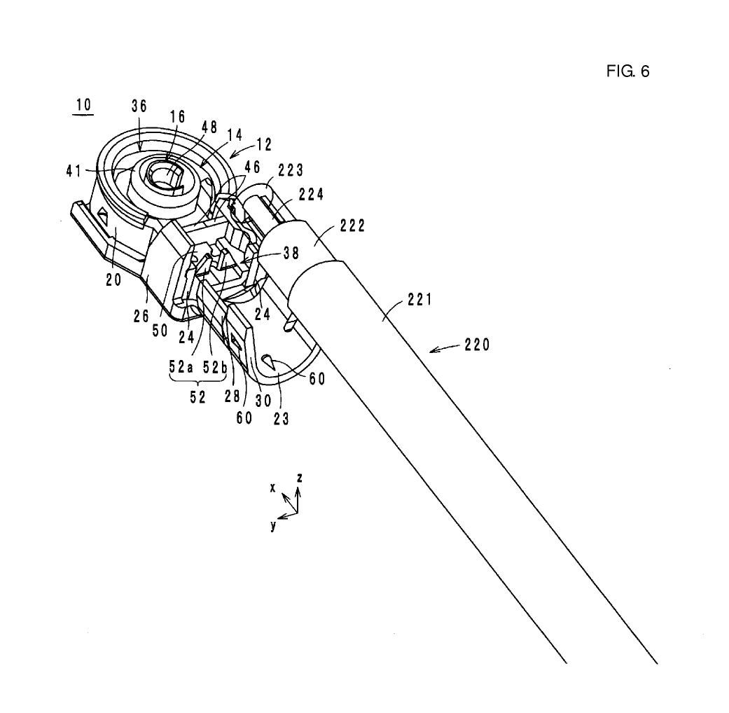

The coaxial connector 10 configured as described above is assembled by the following procedure. FIGS. 5 and 6 are exploded perspective views in the middle of assembly of the coaxial connector 10.

First, as shown in FIG. 5, the socket 16 is attached to the bushing 14. To be more specific, the socket 16 is pinched from both sides in the y-axis direction by the bushing so that the cylindrical part 48 is housed in the cylindrical portion 41, and the rear surface part 50 is arranged in the gaps Sp.

Then, as shown in FIG. 6, the bushing 14 is attached to the housing 12. To be more specific, the bushing 14 is pressed and attached to the housing 12 from the positive-direction side in the z-axis direction so that the circular part 36 is housed in the cylindrical part 20 and the holding part 38 is arranged between the fixing parts 24.

Then, as shown in FIG. 6, the coaxial cable 220 is mounted on the attachment part 52. At this time, the coaxial cable 220 is processed so that the outer conductor 222 and the insulating body 223 are exposed at the distal end. However, the central conductor 224 is not exposed. The coaxial cable 220 is mounted on the socket 16 so that the insulating body 223 is located above the attachment part 52, the outer conductor 222 is located in the crimp portion 28, and the insulating film 221 is located in the crimp portion 30.

After the coaxial cable 220 is mounted, crimping steps of the crimp portions 26, 28, and 30 are performed. In the crimping step of the crimp portion 26, the crimp portion 26 is bent and hence the insulating body 223 is pressed to the cutting pieces 52a and 52b. At this time, a portion of the insulating body 223 is cut by the cutting pieces 52a and 52b, and the cutting pieces 52a and 52b are connected to the central conductor 224.

Also, in the crimping step of the crimp portion 28, the crimp portion 28 is bent and hence the crimp portion 28 is wound around the outer conductor 222. Similarly, in the crimping step of the crimp portion 30, the crimp portion 30 is bent and hence the crimp portion 30 is wound around the insulating film 221. After the above-described steps, the coaxial connector 10 obtains the configuration as shown in FIG. 1.

Next, attachment and detachment of the coaxial connector 10 to and from the receptacle 230 are described. As shown in FIG. 3, the receptacle 230 includes the outer conductor 232 and the central conductor 234. The outer conductor 232 is a cylindrical electrode. The central conductor 234 is an electrode protruding toward the negative-direction side in the z-axis direction at the center of the outer conductor 232.

When the coaxial connector 10 is mounted on the receptacle 230, the outer conductor 232 is inserted into the cylindrical part 20 from the opening O1 as shown in FIGS. 3(a) and 3(b). Accordingly, the inner peripheral surface of the cylindrical part 20 contacts the outer peripheral surface of the outer conductor 232, and hence the outer conductor 222 of the coaxial cable 220 is electrically connected with the outer conductor 232 of the receptacle 230 through the housing 12. At this time, the cylindrical part 20 is expanded by the outer conductor 232. Accordingly, the inner peripheral surface of the cylindrical part 20 is crimped to the outer peripheral surface of the outer conductor 232. The coaxial connector 10 is prevented from being easily detached from the receptacle 230.

Also, at the same time when the outer conductor 232 is inserted into the cylindrical part 20, the central conductor 234 is inserted into the cylindrical part 48 of the socket 16 as shown in FIGS. 3(a) and 3(b). Accordingly, the outer peripheral surface of the central conductor 234 contacts the inner peripheral surface of the cylindrical part 48, and hence the central conductor 224 of the coaxial cable 220 is electrically connected with the central conductor 234 of the receptacle 230 through the socket 16.

### Advantages

With the coaxial connector 10 configured as described above, the coaxial connector 10 can be prevented from being detached from the coaxial cable 220 including the insulating body 223 having the foam structure or the hollow structure. To be more specific, since the coaxial cable 220 uses the insulating body 223 having the foam structure or the hollow structure, the elasticity of the coaxial cable becomes low. Hence, when the coaxial cable 220 is held by the crimp portions 126 and 130, since the coaxial cable 220 has a low repulsive force, the coaxial cable 220 may be detached from the L-type coaxial connector 110.

To prevent the detachment, in the coaxial connector 10, as shown in FIGS. 1, 2, and 4, the crimp portion 30 has the plurality of protrusions 60 at the surface which contacts the insulating film 221. Accordingly, when the crimp portion 30 is wound around the insulating film 221, the protrusions 60 stick to or bite into the insulating film 221. Consequently, the crimp portion 30 sufficiently strongly holds the insulating film 221 without increasing the force by which the crimp portion 30 is crimped to the insulating film 221. Hence, the coaxial connector 10 is prevented from being detached from the coaxial cable 220 including the insulating body 223 having the foam structure or the hollow structure.

Also, in the coaxial connector 10, each of the protrusions 60 has an isosceles triangle shape in which the apex is farther from the cylindrical part 20 than the base is in plan view in the protruding direction. In the protrusion 60, the most protruding portion toward the insulating film 221 is the midpoint of the base of the isosceles triangle. Accordingly, when the coaxial cable 220 is pulled to the negative-direction side in the x-axis direction, a portion at the base of the protrusion 60 is hooked to the insulating film 221. Consequently, the coaxial connector 10 is further effectively prevented from being detached from the coaxial cable 220.

First Modification

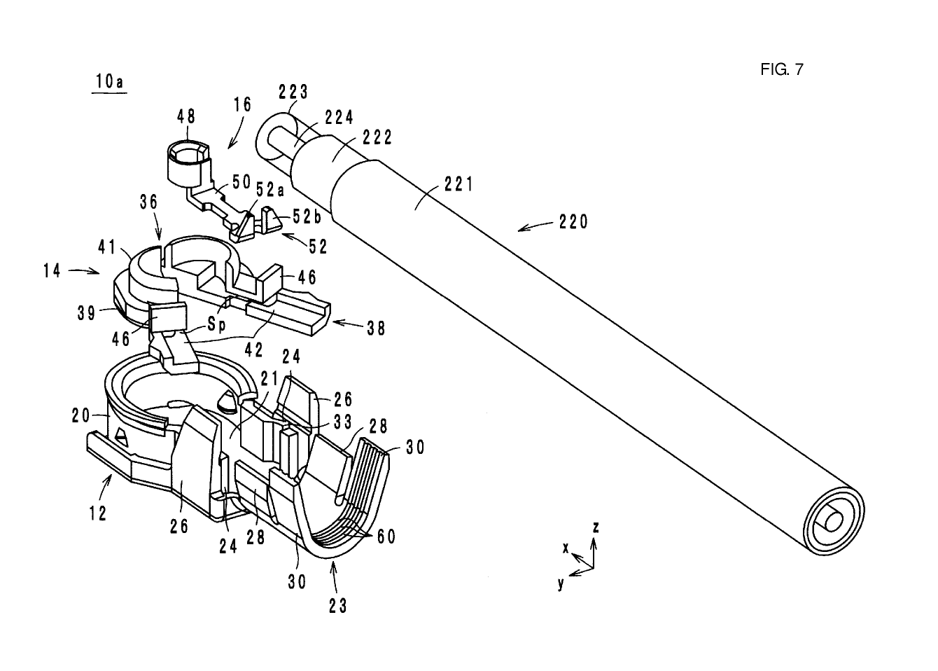

Hereinafter, a coaxial connector 10a according to a first modification is described with reference to the drawings. FIG. 7 is an exploded perspective view of the coaxial connector 10a according to the first modification.

The coaxial connector 10a differs from the coaxial connector 10 for the shape of protrusions 60. As shown in FIG. 7, the protrusions 60 of the coaxial connector 10a each have a line shape extending around the insulating film 221 when the crimp portion 30 holds the insulating film 221. Also, as shown in FIG. 7, the plurality of protrusions 60 are provided to be parallel to each other.

Similarly to the coaxial connector 10, the coaxial connector 10a is also prevented from being detached from the coaxial cable 220 including the insulating body 223 having the foam structure or the hollow structure.

Second Modification

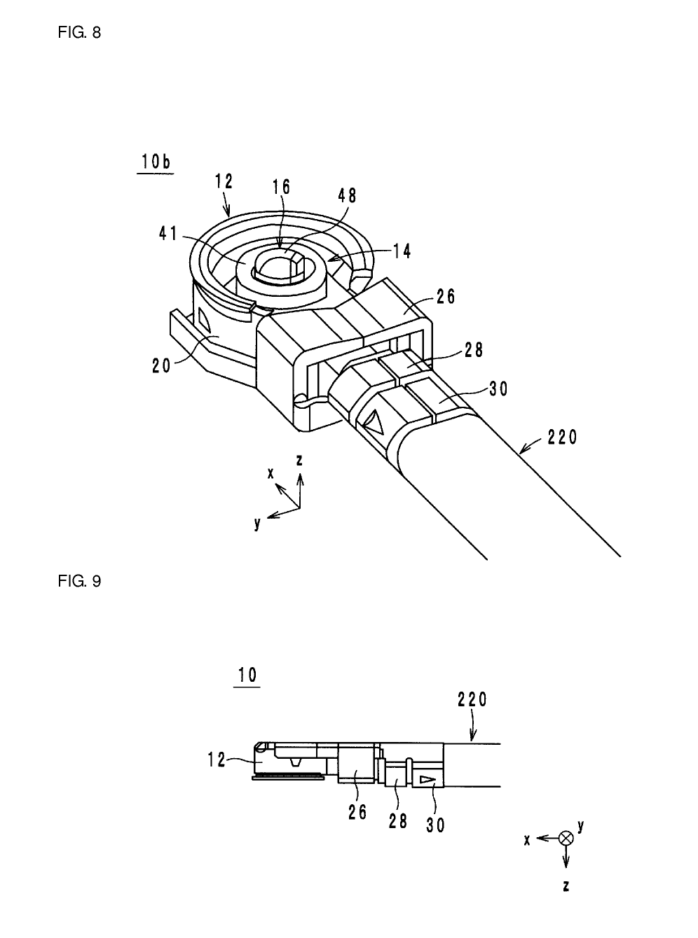

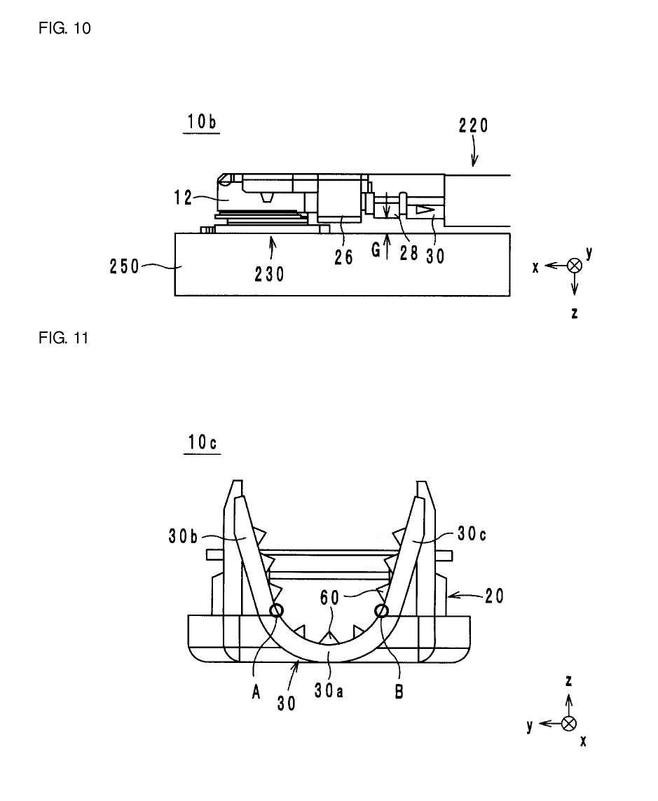

Hereinafter, a coaxial connector 10b according to a second modification is described with reference to the drawings. FIG. 8 is an external perspective view of the coaxial connector 10b according to the second modification. FIG. 9 is a plan view in the y-axis direction of the coaxial connector 10 in FIG. 1. FIG. 10 is a plan view in the y-axis direction of the coaxial connector 10b in FIG. 8.

The coaxial connector 10b differs from the coaxial connector 10 for the structures of crimp portions 28 and 30. To be more specific, the coaxial cable 220 has a circular sectional structure. Hence, in the coaxial connector 10, the crimp portions 28 and 30 are wound around the coaxial cable 220 so as to have circular shapes in plan view in the x-axis direction.

In contrast, in the coaxial connector 10b, the widths in the z-axis direction of the crimp portions 28 and 30 are smaller than the widths in the y-axis direction of the crimp portions 28 and 30 as shown in FIG. 8. That is, the crimp portions 28 and 30 are wound around the coaxial cable 220 so as to have elliptic shapes with major axes being parallel to the y-axis direction in plan view in the x-axis direction. In the coaxial connector 10b, similarly to the coaxial connector 10 in FIG. 1, the crimp portions 28 and 30 are wound so as to have circular shapes, and then the crimp portions 28 and 30 are squeezed from both sides in the z-axis direction.

With the coaxial connector 10b configured as described above, the coaxial connector 10b is further effectively prevented from being detached from the coaxial cable 220. To be more specific, in the coaxial connector 10b, the crimp portions 28 and 30 are further squeezed from both sides in the z-axis direction, from the state of the crimp portions 28 and 30 of the coaxial connector 10 shown in FIG. 1. Accordingly, the crimp portions 28 and 30 bite into the coaxial cable 220, and are further rigidly fixed to the coaxial cable 220. Consequently, the coaxial connector 10b is further effectively prevented from being detached from the coaxial cable 220.

Also, with the coaxial connector 10b, the crimp portions 28 and 30 can prevent the crimp portions 28 and 30 from contacting a circuit board 250. To be more specific, in the coaxial connector 10b, the crimp portions 28 and 30 are further squeezed from both sides in the z-axis direction, from the state of the crimp portions 28 and 30 of the coaxial connector 10 shown in FIG. 1. Accordingly, the widths in the z-axis direction of the crimp portions 28 and 30 are smaller than the widths in the y-axis direction of the crimp portions 28 and 30. Hence, as shown in FIGS. 9 and 10, the widths in the z-axis direction of the crimp portions 28 and 30 of the coaxial connector 10b are smaller than the widths in the z-axis direction of the crimp portions 28 and 30 of the coaxial connector 10. As shown in FIG. 10, when the coaxial connector 10b is mounted on the receptacle 230, a gap G between the circuit board 250 with the receptacle 230 mounted thereon and the crimp portions 28 and 30 is increased. Hence, the circuit board 250 hardly contacts the crimp portions 28 and 30. Consequently, when the coaxial connector 10b is mounted on the receptacle 230, a phenomenon, in which the crimp portions 28 and 30 are hooked to the circuit board 250, a stress is concentrated at the crimp portions 28 and 30, and the coaxial connector 10b becoming detached from the coaxial cable 220, is prevented from occurring. Also, a phenomenon, in which the circuit board 250 is broken because the crimp portions 28 and 30 contact the circuit board 250, is prevented from occurring. Further, a phenomenon, in which a short-circuit occurs because the crimp portions 28 and 30 contact a land on the circuit board 250, is prevented from occurring.

It is to be noted that, when the crimp portions 28 and 30 are squeezed in the z-axis direction, an appropriate force is required to be applied to the crimp portions 28 and 30. If the force to be applied to the crimp portions 28 and 30 is too large, the crimp portions 28 and 30 may be excessively squeezed in the z-axis direction. At this time, the crimp portions 28 and 30 tend to be expanded in the y-axis direction. If the crimp portions 28 and 30 are expanded in the y-axis direction, the protrusions 60 contacting the coaxial cable 220 from both sides in the y-axis direction may be detached from the coaxial cable 220. Hence, the crimp portions 28 and 30 are preferably squeezed by a certain degree so that the protrusions 60 are not detached from the coaxial cable 220. It is to be noted that, when the crimp portions 28 and 30 are squeezed in the z-axis direction, the crimp portions 28 and 30 are preferably pressed from both sides in the y-axis direction so that the crimp portion 28 or 30 does not expand in the y-axis direction.

Third Modification

Hereinafter, a coaxial connector 10c according to a third modification is described with reference to the drawings. FIG. 11 is a plan view in the x-axis direction of the coaxial connector 10c when the crimp portion 28 or 30 is not wound around the coaxial cable 220.

The crimp portion 30 includes an arc portion 30a and line portions 30b and 30c before the crimp portion 30 is wound around the coaxial cable 220. The arc portion 30a has an arc shape in plan view in the x-axis direction. In this modification, the arc portion 30a has a semicircular shape protruding toward the negative-direction side in the z-axis direction. The line portion 30b linearly extends from an end portion at the positive-direction side in the y-axis direction of the arc portion 30a toward the positive-direction side in the z-axis direction in plan view in the x-axis direction. The line portion 30c linearly extends from an end portion at the negative-direction side in the y-axis direction of the arc portion 30a toward the positive-direction side in the z-axis direction in plan view in the x-axis direction. The distance in the y-axis direction between the line portions 30b and 30c is increased toward the positive-direction side in the z-axis direction.

As shown in FIG. 11, nine protrusions 60 are provided. However, a protrusion 60 is not provided at the boundary A between the arc portion 30a and the line portion 30b, or the boundary B between the arc portion 30a and the line portion 30c.

With the coaxial connector 10c configured as described above, a crack is prevented from being generated in the crimp portion 30. To be more specific, the protrusions 60 are formed by pressing the outer peripheral surface of the crimp portion 30. Hence, recess portions are formed at positions corresponding to the protrusions 60, at the outer peripheral surface of the crimp portion 30. Accordingly, the strength of a portion of the crimp portion 30 provided with the protrusions 60 is lower than the strength of other portions of the crimp portion 30.

Also, the curvature radius of the crimp portion 30 is changed at the boundary A and the boundary B. Hence, if the crimp portion 30 is wound around the coaxial cable 220, a stress is concentrated at the boundary A and the boundary B. Accordingly, if the protrusions 60 are provided at the boundary A and the boundary B, a crack may be generated at the boundary A and the boundary B of the crimp portion 30. Hence, in the coaxial connector 10c, a protrusion 60 is not provided at the boundary A or the boundary B. Accordingly, a crack is prevented from being generated at the crimp portion 30.

Fourth Modification

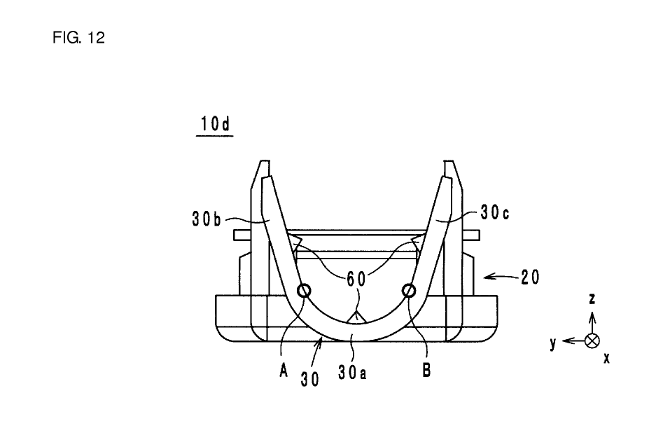

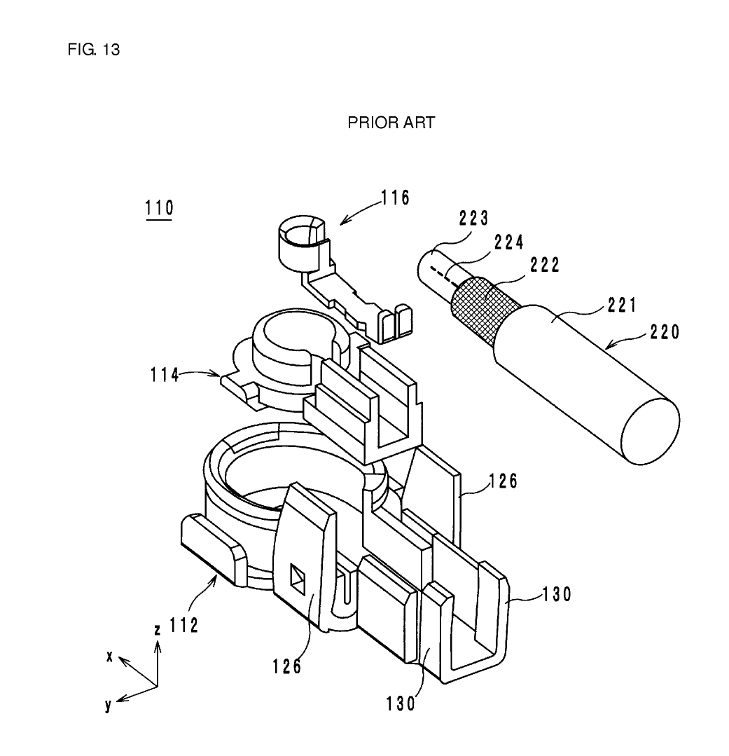

Hereinafter, a coaxial connector 10d according to a fourth modification is described with reference to the drawings. FIG. 12 is a plan view in the x-axis direction of the coaxial connector 10d when the crimp portion 28 or 30 is not wound around the coaxial cable 220.

The coaxial connector 10d differs from the coaxial connector 10c for the number of protrusions 60. In the coaxial connector 10d, the protrusions 60 are provided at a portion at the negative-direction side in the z-axis direction of the inner peripheral surface of the crimp portion 30, and portions at both sides in the y-axis direction of the inner peripheral surface of the crimp portion 30.

As shown in FIG. 12, by decreasing the number of protrusions 60 as compared with the case of the coaxial connector 10c, the coaxial connector 10d can be more easily processed than the coaxial connector 10c. Also, the strength of the crimp portion 30 is increased.

### INDUSTRIAL APPLICABILITY

As described above, the disclosure is useful for a coaxial connector, and in particular, the disclosure is advantageous in that the coaxial connector can be prevented from being detached from the coaxial cable including the insulating body having the foam structure or the hollow structure.

1. A coaxial connector that is attached to a coaxial cable, the coaxial cable including a first central conductor, an insulating body provided around the first central conductor and having a foam structure or a hollow structure, a first outer conductor provided around the insulating body, and an insulating film provided around the first outer conductor, the insulating film being removed at a distal end of the coaxial cable and the first outer conductor being exposed, the first outer conductor being removed at the distal end of the coaxial cable and the insulating body being exposed, the coaxial connector comprising:
a housing including a cylindrical part having a central axis being substantially orthogonal to an extending direction of the coaxial cable, and a holding part extending from the cylindrical part along the coaxial cable;
a bushing attached to the housing; and
a socket located at a center of the cylindrical part in plan view in a direction in which the central axis extends, insulated from the housing by the bushing, and connected to the first central conductor,
the holding part including
a first crimp portion for holding the first outer conductor, and
a second crimp portion for holding the insulating film,
the second crimp portion having a protrusion at a surface which contacts the insulating film.

2. The coaxial connector according to claim 1, wherein the holding part further includes a third crimp portion that holds the bushing.

3. The coaxial connector according to claim 1, wherein the second crimp portion is a plate-like member that is wound around the insulating film.

4. The coaxial connector according to claim 3, wherein widths of the first crimp portion and the second crimp portion in the direction in which the central axis extends are smaller than widths of the first crimp portion and the second crimp portion in a direction orthogonal to the direction in which the central axis extends and the extending direction.

5. The coaxial connector according to claim 3,
wherein the second crimp portion includes an arc portion having an arc shape in plan view in the extending direction, a first line portion connected to one end of the arc portion, and a second line portion connected to the other end of the arc portion before the second crimp portion is wound around the coaxial cable, and
wherein the protrusion is spaced from a boundary between the arc portion and the first line portion or a boundary between the arc portion and the second line portion.

6. The coaxial connector according to claim 3, wherein the protrusion has a line shape extending around the insulating film when the second crimp portion holds the insulating film.

7. The coaxial connector according to claim 1, wherein the protrusion protrudes in a sharp form toward the insulating film.

8. The coaxial connector according to claim 7,
wherein the protrusion has an isosceles triangle shape in which an apex is farther from the cylindrical part than a base is in plan view in a protruding direction of the protrusion, and
wherein a most protruding portion of the protrusion toward the insulating film is a midpoint of the base.

9. The coaxial connector according to claim 8, wherein there are a plurality of the protrusions.

10. The coaxial connector according to claim 1,
wherein a cylindrical second outer conductor of a receptacle is inserted into the cylindrical part, and
wherein a second central conductor of the receptacle is connected to the socket.
